(19) United States
(12) Patent Application Publication
(10) Pub. No.: US 2026/0033619 A1
(43) Pub. Date: Feb. 5, 2026

(54) Bamboo Net, Devices and Methods of use

(71) Applicants: Keshav RASTOGI, Cupertino, CA (US); Praneel SHAH, Cupertino, CA (US)

(72) Inventors: Keshav RASTOGI, Cupertino, CA (US); Praneel SHAH, Cupertino, CA (US)

(21) Appl. No.: 19/283,631

(22) Filed: Jul. 29, 2025

Related U.S. Application Data
(60) Provisional application No. 63/677,162, filed on Jul. 30, 2024.

(51) Int. Cl. A45F 3/52; A01N 25/34; A01N 65/26; A47C 29/00

(52) U.S. Cl. CPC A45F 3/52; A01N 25/34; A01N 65/26; A47C 29/006

(57) ABSTRACT

The present disclosure relates to devices of a bamboo net, and methods of manufacturing a bamboo net. In aspects, the net includes a mesh having an n-sided polygon aperture, wherein n is 5 or more. In aspects, the net includes a mesh comprises a bamboo/biopolymer composite.

### CROSS-REFERENCE TO RELATED APPLICATION

This application claims the benefit of U.S. Provisional Application No. 63/677,162, filed Jul. 30, 2024, the contents of which are incorporated herein in its entirety.

### FIELD OF THE INVENTION

The present disclosure relates to the use and methods for bamboo nets. The present disclosure also related to the use and methods for mosquito nets made from a bamboo slurry.

### BACKGROUND OF THE INVENTION

Malaria and other insect-borne diseases are a predominant issue facing many developing countries. See Ahorlu et al., “Understanding the gap between access and use: a qualitative study on barriers and facilitators to insecticide-treated net [ITN] use in Ghana” Malaria Journal. 18:1 (2019); Nigeria U.M. “U.S. Donates 3.6 Million Insecticide-treated Bed Nets to Control Malaria in Benue State” U.S. Embassy and Consulate in Nigeria. U.S. Embassy And Consulate in Nigeria (2022). Current preventative measures include the use of insecticide-treated nets. Insecticide-treated nets commercially available lack breathability due to the rectangular mesh structure. Many developing countries at increased risk for insect-borne diseases are located in hot and humid regions where breathability of nets is an important consideration. Lack of net breathability decreases overall use of insecticide-treated nets. See “Better load distribution and lower shrinkage with Hexagonal mesh design—AKVA group” AKVA group (n.d).

Further, commercially available insecticide-treated nets utilize synthetic fabrics and chemical insecticides which are unfamiliar to many consumers. Lack of familiarity with the materials of the net decreases overall use of insecticide-treated nets. See Uushona, S. I. et al., “Sociocultural factors that influence the prevention of malaria in Ohangwena region, Namibia” African Journal of Primary Health Care & Family Medicine, 14:1 (2022); Ahorlu et al., “Understanding the gap between access and use: a qualitative study on barriers; and facilitators to insecticide-treated net use in Ghana” Malaria Journal. 18:1 (2019); and Mpi “Rotary Club of Kakamega, Kenya Mosquito Net Distribution Small Grant” Malaria Partners International (n.d.).

Sustainability is an important consideration for insecticide-treated nets both in environmental impact and cost-efficiency of consumers. Current insecticide-treated nets harness chemicals and plastics which are more costly and environmentally harmful than natural alternatives. See Xu, D. et al., “Replacing Plastic with Bamboo: A Review of the Properties and Green Applications of Bamboo-Fiber-Reinforced Polymer Composites” Polymers, 15:21, 4276 (2023); Li, H. et al., “Research and Utilization Status of Natural Bamboo Fiber” Advanced Materials Research, 159, 236-241 (2010); and Lindsay, S. W., et al., “Threats to the effectiveness of insecticide-treated bednets for malaria control: thinking beyond insecticide resistance” The Lancet Global Health, 9:9, e1325-e1331 (2021).

Devices and methods for using bamboo nets as a breathable, familiar, and sustainable alternative to traditional insecticide-treated nets are described herein. Devices and methods described herein provide for improved use of nets in developing countries and decreases the risk of insect-borne diseases.

### SUMMARY OF THE INVENTION

A net comprising; a supporting structure; a mesh having an n-sided polygon aperture and comprising a bamboo/biopolymer composite, where n is 5 or more, and where the mesh is impregnated with insect repellant.

A method for manufacturing a net, comprising steps of: A) combining poly-3-hydroxybutyrate (PHB) with bamboo pulp in a slurry to form a bamboo/PHB composite; and B) molding the bamboo/PHB composite, such that a mesh with an n-sided shaped aperture is formed, where n is 5 or more.

A net comprising; a mesh having an n-sided polygon aperture, where n is 5 or more, and where the mesh comprises a bamboo/biopolymer composite.

### BRIEF DESCRIPTION OF THE DRAWINGS

Some aspects of the disclosure are herein described, by way of example only, with reference to the accompanying drawings. With specific reference now to the drawings in detail, it is stressed that the particulars shown are by way of example and are for purposes of illustrative discussion of aspects of the disclosure. In this regard, the description, taken with the drawings, makes apparent to those skilled in the art how aspects of the disclosure may be practiced.

FIG. 1 shows an improved insect net.

FIGS. 2a to 2h show example patterns for apertures for the insect nets described herein.

FIGS. 3a to 3c show further example apertures for the insect nets described herein.

FIG. 4 shows a process of manufacturing a bamboo composite described herein.

FIGS. 5a and 5b depict methods of manufacturing or producing insect net structures.

FIGS. 6a and 6b show respective insert scaled views of aspects of bamboo-polymer composite.

Corresponding reference characters indicate corresponding parts throughout the several views. The examples set out herein illustrate several aspects of the invention but should not be construed as limiting the scope of the invention in any manner.

In light of current technology, there is a need for improved insect nets and use of such improved nets.

### DETAILED DESCRIPTION

To address such needs and others, the present disclosure includes and provides devices and methodology for the prevention of insect (e.g., mosquito) entrance within an enclosed space.

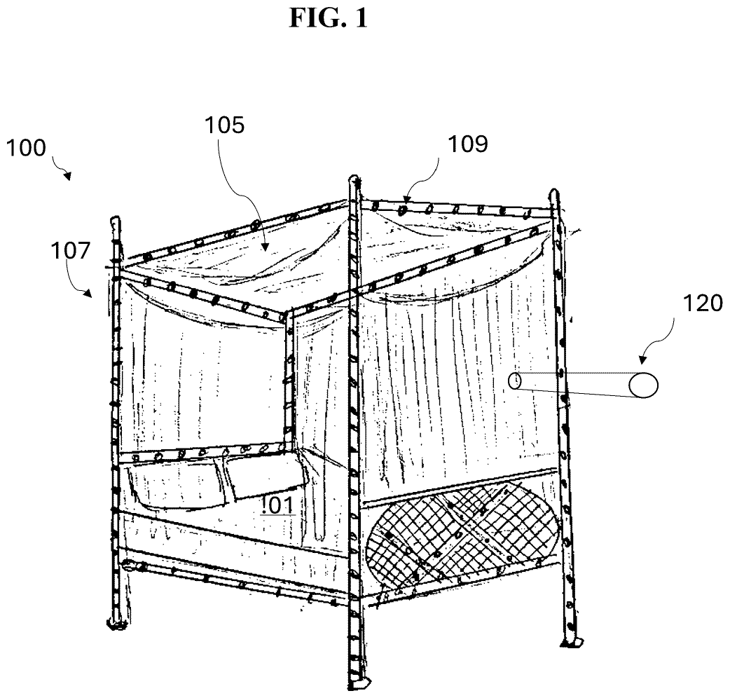

FIG. 1 shows an improved insect net structure 100. It can be understood the insect net structure 100 can be used in the prevention of the entrance of insects in a volume of space. It can be understood the insect net structure 100 can be constructed to enclose one or more spaces frequented by humans or livestock, such as kitchens, outdoor spaces, couches, tables, and the like. For example, bed nets can surround individuals during sleep. In some aspects, the insect net structure is constructed for the prevention of insect entrance within an space that surrounds (e.g., above, and/or surrounding, above a bed. As such, the insect net structure 100 can be manufactured with a bed 100 or can be a separate accessory to existing beds 100.

In an aspect, insect net structure 100 includes a mesh 105. A mesh can be made from one or more polymers. In some communities, non-natural materials may foster hesitancy. In example aspects, the mesh 105 is made from a biopolymer, which may be of natural original and thus combat some hesitancies around non-natural materials, and thus also increase eco-friendliness of the net structure 100 (for example, as compared to plastics). In examples, the biopolymer is Polyhydroxybutyrate (PHB) or poly-3-hydroxybutyrate. In aspects, the PHB can be created via the metabolic processes of bacterial strains. In aspects, the mesh 105 may be a polymer composite blend. In aspects the mesh 105 may be a biopolymer composite blend. In aspects, the mesh 105 is a bamboo/PHB composite. A specific flavonoid is abundant in bamboo, quercetin. Benefits of quercetin to specific aspects will be disclosed below, including benefits related to UV resistance and thus maintained durability, and enhanced adhesion of insecticides when insecticides are used.

In an aspect, use of bamboo in the composite may contribute to the insect net structure's 100 improved breathability and permeability, thus ensuring greater comfort. In aspects, the use of bamboo in the composite may contribute to improved slow-release capabilities for composite that include insecticide, and longer life-span. In aspects described herein, the use of bamboo in the mesh 105, may allow for a robust approach to securing an insecticide to the mesh 105.

In an aspect, material (e.g., bamboo) used together with a polymer in the composite, may be selected for improved tensile strength. For example, the use of bamboo in a bamboo/PHB blend may increase the tensile strength as compared to a PHB bio-polymer (without the bamboo). In aspects, use of bamboo in the mesh 105 may enhance the durability and metallic-like strength, thereby enhancing cost-efficiency without compromising on quality. In aspects, either the polymer or composite materials in composites thereof, are selected for their flexibility and/or weight. For example, a lightweight material may increase packability.

In an aspect, mesh 105 is insecticide treated. In some of such cases, insect net structure 100 may be called an Insecticide-Treated Net (ITN). In some communities, non-natural insecticides used in ITNs foster hesitancy and lack of acceptance of the ITNs. The insecticide may be selected to be of natural origin (or a bio-insecticide), which may combat hesitancies around non-natural insecticides. In aspects, the bio-insecticide is Azadirachtin.

In an aspect, mesh 105 is a PHB/insecticide composite blend. In some aspects the mesh is a bamboo/PHB/insecticide composite blend. For example, the bamboo:PHB is about 30:1, 25:1, 20:1, 10:1, 5:1, or 2:1. For example, the insecticide makes up less than 1.5%, 1.5%-3%, greater than 3% by weight of the composite blend. For example, the insecticide makes up less than 1.5%, 1.5%-3%, greater than 3% by volume of the composite blend. Second, unfamiliar synthetic materials and non-natural insecticides foster hesitancy and lack of acceptance in some communities. Illustrated, many of these subjective factors—such as fear of chemicals—are truly important and greatly impede ITN usage and adoption.

In an aspect, mesh 105 can be mechanically coupled with a supporting structure, such as a frame 107. For example, mesh 105 can be draped over the frame 107. In aspects, the frame 107 can be made from a metal, or plastic. In aspects, frame 107 can be made from a natural material, such as paper, wood (e.g., balsa), or bamboo. In aspects, the frame 107 does not include synthetic plastics, which may increase eco-friendliness. In aspects, material selected for the frame 107 aligns with the social-cultural context of where the net structure 100 will be used. Furthermore, material the frame 107 is made out of can be selected based on at least one of a tensile strength, flexibility, and durability. For example, bamboo may provide as compared to metal, substantially increased structural integrity, yet also retained flexibility, over a considerably long lifetime. In an aspect, properties of the material selected across a specific dimension or orientation for the material may be used in selecting the material. In an aspects the frame 107 material is selected for load distribution. In an aspect, shape of the frame 107, is constructed for load distribution. In an aspect, use of bamboo in the frame 107 may enhance the durability and metallic-like strength of the structure 100, thereby enhancing cost-efficiency without compromising on quality.

In an aspect, frame 107 of the net structure 100 is integrated with (either integral to or a as a separate piece) one or more other items in spaces, such as a bed frame, a couch, kitchen cabinetry, housing structures or fixtures, etc. In an aspect, frame 107 can be coupled to the mesh 105 via one or more attachment mechanism 109. Attachment mechanism 109 can include at least one of a magnetic, or other removable fastener, such as rings, magnet, velcro which can allow for mobility of mesh 105 with respect to the frame, and for selective opening of the mesh to allow for access to a volume of space enclosed by the net. In aspects, the attachment mechanism allows for complete removal of mesh with respect to the frame, for example for purposes of cleaning mesh 105.

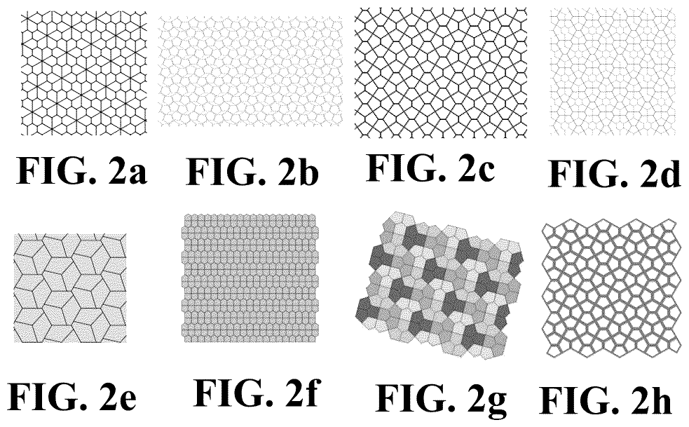

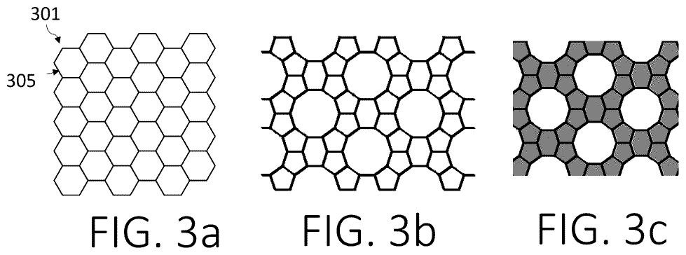

In an aspect, mesh 105 includes one or more apertures created when material making up the mesh surrounds one or more openings. FIGS. 2a-3c show example patterns for apertures for insect nets described herein. In an aspect, one or more apertures disclosed in FIGS. 2a-3c are representative of one or more apertures of the mesh 105 show in in FIG. 1, e.g., at insert 120. In aspects, the mesh 105 has an aperture according to 4-mesh, 10-mesh, 20-mesh, 30-mesh, 40-mesh, 50-mesh, and 60-mesh. In aspects, an aperture prevents the entrance of one or more insects or pests, so the aperture size is tailored to prevent the entrance of one or more insects or pests. In an aspect, a greater diameter of an aperture is selected based on a size of the pest. For example, the greatest diameter of an aperture can be less than the size of the smallest diameter of a cross section of the insect. In practice, an opening created by the material surrounding the aperture, may be small enough to prevent insect (e.g., mosquito) penetration. In an aspect, an aperture is about 0.5 mm to 12 mm in diameter. In an aspect, n aperture is selected to be substantially polygonal, with 5 or more sides. In an aspect, a number of sides of the aperture is selected to be greater than 4 for improved breathability as compared to polygonal apertures of 3 or 4 sides. For example, a hexagonal pattern may allow for increased transfer of air which can make it much easier for individuals to breathe as compared to square patterns for the mesh. In an aspect, a number of sides for the polygonal aperture is selected to increase airflow by 5%, 10%, 15%, 25%, 30%, or 40% as compared to a baseline rectangular aperture. For example, a hexagonal pattern may increase airflow by around 25%. In aspects, the number of sides and/or pattern thereof is selected to decrease airflow resistance, and/or to optimize the material-to-surface area ratio. For example, a rectangular pattern may increase airflow resistance as compared to a hexagonal pattern, and may results in fewer openings for a given surface area and reduced airflow, hindering free air movement and accumulating heat inside the net, making it difficult for individuals to breathe.

In an aspect, mesh may experience one or more stress or shear forces. For example, when tugged or pulled, either by users or by wind. In aspects, the polygonal shape may be selected to allow for geometrical shifting. Geometrical shifting can be significant as polygons with more sides (such as hexagons) offer enhanced load distribution capabilities as compared to a rectangular polygon. For example, a regular hexagon may offer a thirty-degree increase for each angle compared to rectangular patterns for the mesh. Thus hexagonal meshes can be more flexible under stress, as the angles within each hexagon can easily adjust slightly to absorb stress when it is placed.

In an aspect, a shape for the aperture, and/or the number of sides thereof, is selected based on the overall mesh's ability to absorb or wick moisture. In an aspect, a shape may thus allow for enhanced breathability, and/or cooling effects in hot and/or dry climates. In some aspects, the mesh 105 includes one or more insecticides and a shape selected for the aperture may be such that it allows for effective insecticide dissemination.

In an aspect, a shape for the aperture and/or number of sides for the aperture(s) is selected for durability in view of repeated and/or strong forces on the mesh. In an aspect, a shape and/or number of sides for the aperture is selected to increase and/or decrease the density of material in a given area or areas. This can allow for increased packing efficiency. For example hexagonal meshes boast higher packing efficiency than their rectangular counterparts, meaning they contain more material in a given area. This can also increase their cost-efficiency. In an aspect, a shape and/or number of sides for the aperture is selected to reduce the number of gaps that reduce mosquito penetration and increase user safety. For example, a hexagonal shape may results in smaller gaps than rectangular shapes.

In an aspect, an aperture is substantially orthogonal polygonal. FIGS. 2a-3h show example patterns for apertures for the insect nets described herein, where the aperture is pentagonal. In an aspect, the aperture is non-orthogonal. For example, the angles may be selected to align with (or not), with one or more stress or shear forces that may be experienced. Angles may be selected so that greater angles align in the direction of stress that may be experienced by the mesh.

FIGS. 3a-3c show further example apertures for the insect nets described herein where one or more apertures are hexagonal. FIG. 3a shows orthogonal regular hexagons patterned in a repetitive uniform pattern 301, and each forming respective apertures 305. In an aspect an aperture is an n-sided polygon aperture with interior angles within 25% of the equation ((n−2)×180)÷n. In an aspect, an orthogonal pattern may be appropriate in situations where uniform flexibility is needed.

FIG. 3b shows six sided polygonal apertures, and ten sided polygonal apertures used in the mesh. FIG. 3c shows only a ten sided polygonal apertures, where the shaded portion is not permeable.

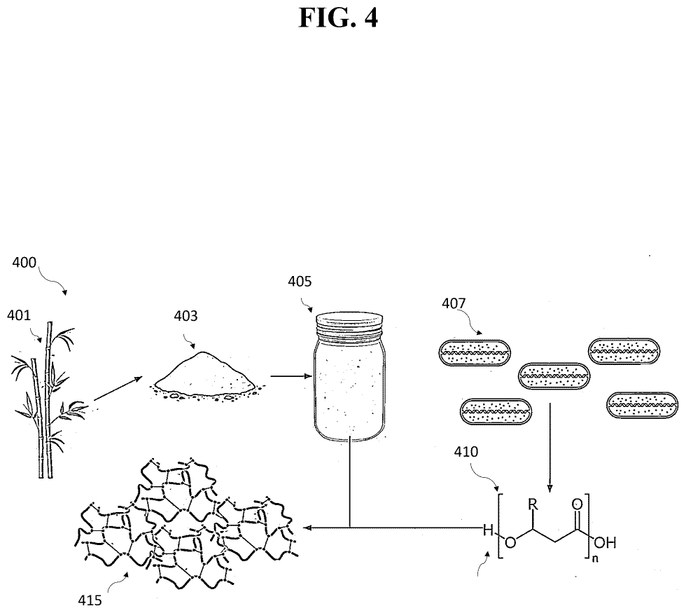

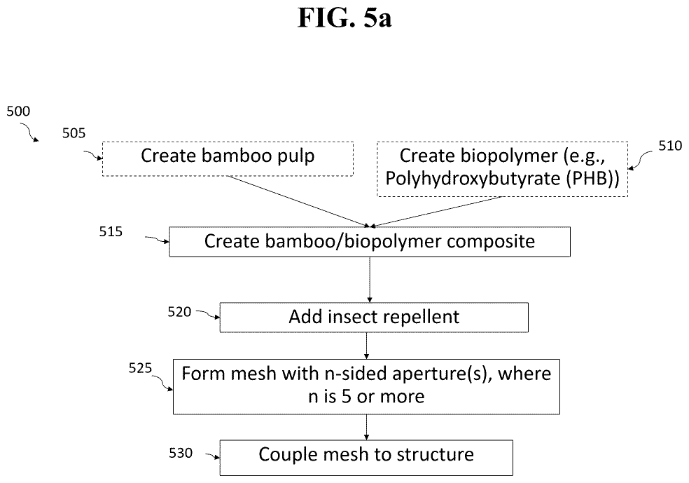

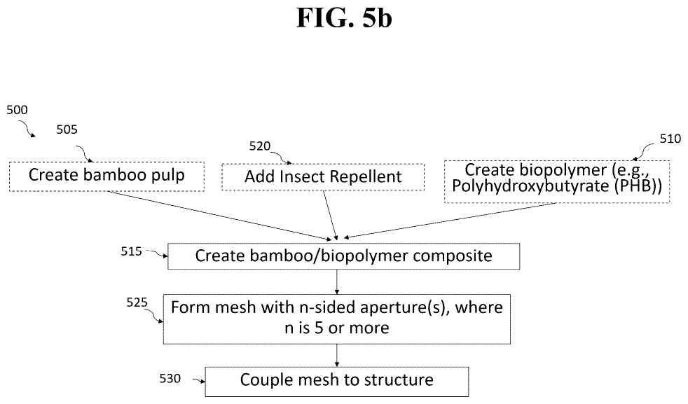

A production process may be selected for insect net structures 100 (or meshes 105). FIG. 4 shows a process 400 of manufacturing a bamboo/polymer composite described herein which can be used as part of processes for producing insect net structures 100 (or meshes 105. FIGS. 5a and 5b shows methods 500 of manufacturing or producing insect net structures 100 (or meshes 105) as described herein. Process 400 and method 500 will be described concurrently.

As part of process 400, bamboo 401 (e.g., in stalk form) is first ground 403 or pulverized into a fine form, and then formed into a pulp 405. Bamboo stalks can be broken into a fine powder using a mechanical system. In an aspect, by utilizing mechanical refiners to breakdown the bamboo 401 stalks, the fibers in the bamboo 401 stalks can increase their flexibility. In aspects, griding or pulverizing the bamboo 401 into a ground 403 form may include extracting one or more bamboo fibers in a fibrous form, that is not necessarily a powdered form.

In some examples, water is added to the ground 403 bamboo to form the pulp 405. In aspects, water is used to form a stable dispersion and a liquid bamboo pulp 405. This dispersion is known as a liquid pulp. In aspects, the water temperature is 20° C. or more, such as 60° C. to 85° C. or 95° C. to 100° C. In an aspect, the ground 403 bamboo (e.g., in powder form) can be subjected to high pressure steam, for example, at a temperature of 160° C. to 260° C. In an aspect, pressure is 0.7 bar or more. In an aspect, pressure is 1 bar or more. In an aspect, pressure is 2 bar or more. In an aspect temperature is 60° C. to 85° C., 95° C. to 100° C., 100° C. to 110° C., 105° C. to 115° C., 120° C. to 110° C., 125° C. to 130° C., 130° C. to 140° C., 140° C. to 145° C., 150° C. to 160° C., 160° C. to 170° C., 175° C. to 180° C., 185° C. to 195° C., 200° C. to 210° C., 210° C. to 220° C., 225° C. to 235° C., 235° C. to 245° C., 255° C. to 265° C., 265° C. to 275° C., 275° C. to 285° C. High pressure will soften the lignocellulosic structure of the bamboo by breaking down the hemicellulose. After a few minutes the pressure cans rapidly reduce causing the fibers to separate. In an aspect, specific flavonoid(s) abundant in bamboo pulp 405 are released via grinding and/or pulp formation processes described herein. In some aspects, specific flavonoids are added as additives in one more processes described herein. In an aspect, a specific flavonoid is abundant in bamboo pulp 405, known as quercetin.

As provided to above, the mesh 105 as disclosed herein may include a bamboo/polymer composite. As part of process 400, in some aspects, a bamboo/polymer composite 415 can be formed by adding an additive, and can be a bamboo/biopolymer composite. The addition of biopolymer PHB, for example can allow for creating an intricate network of bamboo fibers with beneficial properties for the structure 100 or ITN, and the respective mesh 105.

In example process 400, the selected biopolymer is synthesized using Rhodopseudomonas palustris bacteria 407. Rhodopseudomonas palustris bacteria 407 can accumulate PHB granules in their cell walls and PHB can be synthesized by extracting the biopolymer from their cell walls. In order to increase or maximize PHB production the bacteria can be under anoxygenic conditions and produce an ample supply of ATP through iron oxidation and the extracellular electron transport (ETP) pathway. Without limitation with respect to any theory, anoxygenic photosynthesis causes the stored sugar to be used in anaerobic respiration to make Acetyl COA, which ultimately leads to PHB production as energy reserve stored in the bacteria's cell walls. Although an extracted PHB 410 is shown in the process 400, it can be understood that other polymers (and biopolymers specifically) can be used, and the other processes for extracting PHB can be used. In some aspects, raw PHB can be used.

After extracting PHB (see extracted PHB 410), the extracted PHB 410 is combined with bamboo pulp 405 to form a bamboo/polymer composite 415, e.g., a bamboo/PHB composite 415. In some aspects, the ratio is 1:10 by weight. For example, one kilogram of PHB can be combined with 10 kilograms of dry bamboo fiber. In an aspect, the PHB is expected to coat the bamboo fibers.

In an aspect, bamboo/polymer composite 415 is in a slurry form. Bamboo pulp 405 may cross-link with the extracted biopolymer PHB 410, which enhances the bamboo fiber's elasticity. Enhanced elasticity may ultimately be beneficial in a process (not shown) which may be used to form one or more patterns of shapes (see e.g., FIGS. 2a-3c) that may make up the mesh 105 described herein.

As provided above, FIGS. 5a and 5b show two aspects of method 500 of manufacturing or producing insect net structures 100 (or meshes 105) as described herein. Method 500 includes a step 505 of creating bamboo pulp. Bamboo pulp may be bamboo pulp 405 shown with reference to process 400 and FIG. 4. Method 500 includes a step 510 of creating a biopolymer (e.g., PHB). Steps 505 and 510 may be completed in any order. The biopolymer created using step 510 may be PHB 410 described with reference to FIG. 4.

Method 500 includes a step 515 for creating a bamboo/biopolymer composite. Step 515 can include the bamboo/biopolymer composite 415 created by the process 400 described with reference to FIG. 4. Method 500 includes a step 520 for adding an insecticide.

In an aspect, the bamboo/polymer composite 415 with reference to FIG. 4 and FIGS. 5a and 5b can be a bamboo/polymer/insecticide, (e.g., a bamboo/PHB/insecticide composite). As provide above, a bioinsecticides, guarantees both familiarity and sustainability in the process 400 as compared to conventional insecticides, and can prove as a more effective alternative to conventional insecticides used in ITNs. Thus during production, a bioinsecticide can be incorporated into the process 400 and method 500. In an aspect, bamboo/PHB composite 415 is integrated with an insecticide at step 520 of method 500. In an aspect, insecticide is a bioinsecticide, e.g., Azardirachtin. In an aspect, the ratio of bioinsecticide is 0.2-5% by weight of the bamboo/PHB/insecticide composite (e.g., in slurry form). In aspects, the bioinsecticide is 0.2-3% by weight of the final mesh 105.

Insecticides described herein may have one or more aromatic components which can be the active components. Although bioinsecticides are described, insecticides described herein are not limited to those of natural form or origin. The aromatic components of Azadirachtin and the flavonoids in bamboo 403 (e.g., quercetin, which can be especially extracted via the process to form the bamboo pulp 405), can experience intermolecular bonding. Intermolecular bonding of the aromatic components of Azadirachtin and the flavonoids in bamboo 403 can form namely as a result of pi-pi interactions and hydrogen bonding. In particularly, the flavonoids in bamboo may be attracted to or bonded to one or more benzene rings in the insecticide (e.g., in the Azadirachtin). Bonds formed by pi stacking (also known as pi-pi stacking) interactions and/or hydrogen bonding can be extremely strong, can enhance the mesh's 105 effectiveness over several years. A specific type of intermolecular attraction unique to aromatic molecules. In addition, by taking advantage of pi-stacking, the mesh 105 will ensure greater durability. In some aspects, hydrogen bonding and pi-pi stacking may result in an attraction approximately ten times stronger than that found in traditional ITNs. In aspects, this enhanced bonding can translate to improved slow-release capabilities and, consequently, a longer lifespan compared to its counterparts.

In an aspect, process 400 and method 500 described for insect net structures 100 (or meshes 105) thereof, promotes in-situ manufacturing given that Rhodopseudomonas palustris bacteria 407 and bamboo 401 can be cultivated in a single location. Processes and methods described herein are additionally scalable and low-cost, to allow for production of vast numbers of INTs.

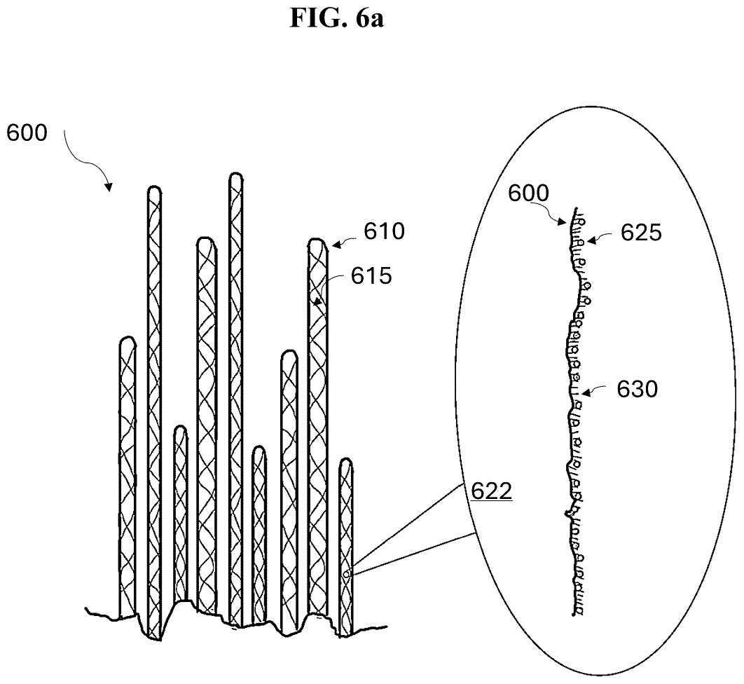

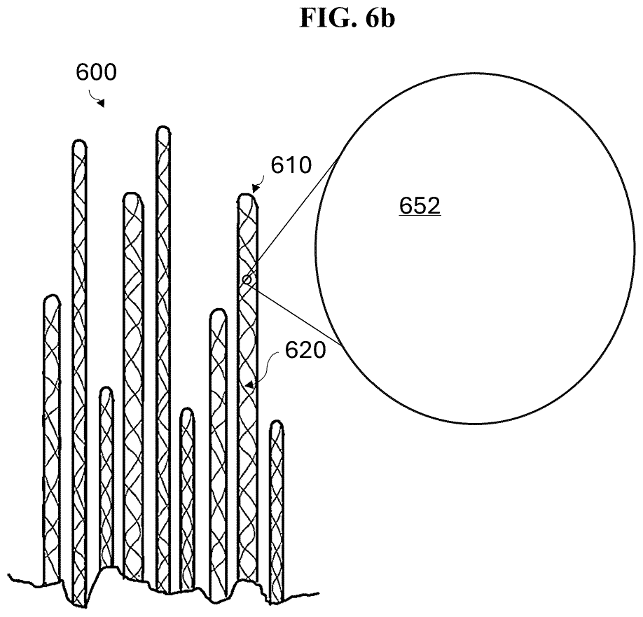

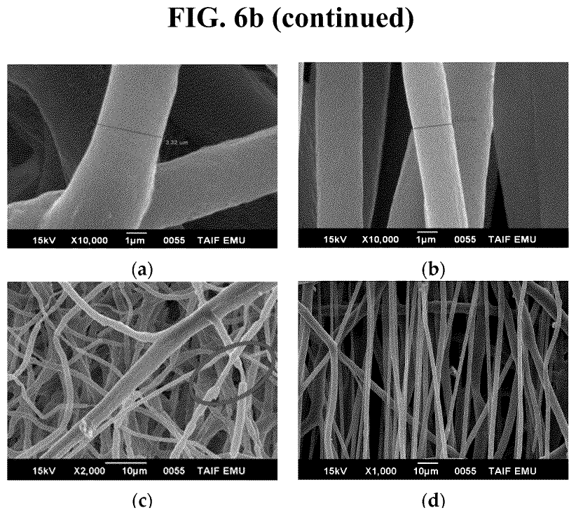

FIGS. 6a and 6b show respective insert scaled views of aspects of bamboo-polymer composite 600. Bamboo-polymer composite 600 can be the bamboo/PHB composite described with reference to FIG. 4 (see bamboo/composite 415) and FIGS. 5a and 5b (see step 515 of method 500). The bamboo-polymer composite 600 depicted is a bamboo/polymer/insecticide composite. FIGS. 6a and 6b show bamboo fibers 610, and PHB fibers 615. In an insert scaled view 622, FIG. 6a shows the aromatic components of an insecticide (e.g., azadirachtin) 625 coupling to the flavonoids 630 (e.g., quercetin) of the bamboo fibers 610. The approximate scale of the insert scale view 622 is a micron to tens of microns. Examples coupling forces such as pi stacking (or pi-pi) interactions and/or hydrogen bonding were previously described with reference to process 400 in FIG. 4. In an insert view 652, FIG. 6b shows an insert scaled view 652 of the PHB fibers 615 at micron (625a, 625b) and ten micron (625c, 625C) scale.

Referring back to the method 500 of FIGS. 5a and 5b, method 500 can include a step 525 for forming a mesh.

In some example aspects, bamboo-polymer (or the bamboo/polymer/insecticide) composite may be used in a molding process, e.g., by injection of the bamboo-biopolymer (or the bamboo/polymer/insecticide) composite slurry or a reduction thereof in a mold) to ultimately forms a mesh 105 having one or more shapes (e.g., the shapes and patterns shown in FIGS. 2a-3c). Reductions of the slurry may be created using at least one of an evaporative, freezing, and/or heating process. In aspects, the slurry is evenly distributed into the mold. A mesh that has a sheet form can thus be created with limited defects through homogeneous distribution among the mold. In aspects, a mold may have a pattern substantially similar to those shown in FIGS. 2a-3c or described with reference to those figures. In aspects, a mold may be made of steel. In aspects, the mold may be made of silicon. In some aspects, a molding process includes one or more processes selected from a group consisting of: injection molding, reaction injection molding, curing, vacuum setting, compression molding, blow molding, thermoforming, extrusion molding, vacuum casting, subtractive manufacturing, and additive manufacturing. In terms of additive manufacturing, the bamboo-biopolymer composite as a slurry, or reduction thereof, can be extruded to form one or more of the shapes of the mesh 105 (e.g., the shapes and patterns shown in FIGS. 2a-3c).

In various aspects, a bamboo, Azadirachtin, and PHB composite blend can be introduced into a mold having one or more apertures (e.g., hexagonal apertures), using injection molding. Once the blend solidifies, it forms a sheet that is then used to construct the mesh 105 (and insect net structure 100 or ITN). Once the mold is cured, the mesh can be removed and inspected for any visible defects. In aspects, the mesh can tested for one or more defects, e.g., by pull tests. In aspects, the mesh can be made an insect net structure 100 (mesh 105 (or ITN)) that is ready for implementation and distribution.

In an aspect, sheets of the mesh can be fitted together to make an insect net structure 100 (mesh 105 (or ITN)) that is ready for implementation and distribution. In aspects, the mesh (or fitted sheets thereof) are coupled to the

In some aspects, only after the bamboo-polymer composite is created and set in a mold, is a bamboo-polymer sheet is created. In aspects, the sheet can then be impregnated with one or more insecticide described herein, such as Azadirachta. As such, with reference to method 500 shown in FIGS. 5a and 5b, it is understood that step 520 for adding an insect repellant, can occur after the mesh is formed in step 525.

Referring back to method 500, method 500 can include a step 530 for coupling the mesh formed at step 525 to a supporting structure. In aspects, the supporting structure referred to with step 530, is frame 107 with reference to insect net structure 100. In aspects, step 530 includes coupling mesh 105 to frame 107, for example, via attachment mechanism 109.

In some aspects, Process 400 and/or process 500 may ensure that the insect net structure 100 or ITN (and the respective mesh 105) is not only robust but also chemically potent, making it a long-lasting solution against malaria or other diseases.

Unless defined otherwise, all technical and scientific terms used have the same meaning as commonly understood by one of ordinary skill in the art to which this disclosure belongs. Where a term is provided in the singular, the inventors also contemplate aspects of the disclosure described by the plural of that term. Where there are discrepancies in terms and definitions used in references that are incorporated by reference, the terms used in this application shall have the definitions given herein. Other technical terms used have their ordinary meaning in the art in which they are used, as exemplified by various art-specific dictionaries, for example, “The American Heritage® Science Dictionary” (Editors of the American Heritage Dictionaries, 2011, Houghton Mifflin Harcourt, Boston and New York), the “McGraw-Hill Dictionary of Scientific and Technical Terms” (6th edition, 2002, McGraw-Hill, New York), or the “Oxford Dictionary of Biology” (6th edition, 2008, Oxford University Press, Oxford and New York).

Before explaining at least one aspect of the disclosure in detail, it is to be understood that the disclosure is not necessarily limited in its application to the details set forth in the following description or exemplified by the Examples. The disclosure is capable of other aspects or of being practiced or carried out in various ways.

Any references cited herein, including, e.g., all patents, published patent applications, and non-patent publications, are incorporated herein by reference in their entireties.

When a grouping of alternatives is presented, any and all combinations of the members that make up that grouping of alternatives is specifically envisioned. For example, if an item is selected from a group consisting of A, B, C, and D, the inventors specifically envision each alternative individually (e.g., A alone, B alone, etc.), as well as combinations such as A, B, and D; A and C; B and C; etc. The term “and/or” when used in a list of two or more items means any one of the listed items by itself or in combination with any one or more of the other listed items. For example, the expression “A and/or B” is intended to mean either or both of A and B—i.e., A alone, B alone, or A and B in combination. The expression “A, B and/or C” is intended to mean A alone, B alone, C alone, A and B in combination, A and C in combination, B and C in combination, or A, B, and C in combination.

As used herein the term “about” refers to ±10%.

The terms “comprises,” “comprising,” “includes,” “including,” “having,” and their conjugates mean “including but not limited to.”

The term “consisting of” means “including and limited to.”

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular forms “a,” “an,” and “the” include plural references unless the context clearly dictates otherwise. For example, the term “a compound” or “at least one compound” may include a plurality of compounds, including mixtures thereof.

Throughout this application, various aspects of this disclosure may be presented in a range format. It should be understood that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, description of a range such as “from 1 to 6” should be considered to have specifically disclosed subranges such as “from 1 to 3,” “from 1 to 4,” “from 1 to 5,” “from 2 to 4,” “from 2 to 6,” “from 3 to 6,” etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques, and procedures for accomplishing a given task including, but not limited to, those manners, means, techniques, and procedures either known to or readily developed from known manners, means, techniques, and procedures by practitioners of the chemical, pharmacological, biological, biochemical, and medical arts.

As used herein, the term “net” refers to open fabric of thread which are looped so as to form a mesh. As used herein, the term “mesh” refers to loosely woven material created by a interlaced thread. In an aspect, the size of the mesh is measured by number of square openings across one inch of the net. In another aspect, the size of the mesh is 4-mesh. In another aspect, the size of the mesh is 10-mesh. In another aspect, the size of the mesh is 20-mesh. In another aspect, the size of the mesh is 30-mesh. In another aspect, the size of the mesh is 40-mesh. In another aspect, the size of the mesh is 50-mesh. In another aspect, the size of the mesh is 60-mesh. In another aspect, the size of the mesh includes, but is not limited to, 4-mesh, 10-mesh, 20-mesh, 30-mesh, 40-mesh, 50-mesh, and 60-mesh.

As used herein, the term “bamboo/biopolymer composite” refers to a material comprising bamboo and biopolymer. In an aspect, a bamboo is in the Phyllostachys species. In another aspect, a bamboo is in the Fargesia species. In another aspect, a bamboo is in the Bambusa species. In another aspect, a bamboo is in the Bambusa species. In another aspect, a bamboo is in the Pseudosasa species. In another aspect, a bamboo is in the Guadadua species. In another aspect, a bamboo can include, but is not limited to, bamboo species Phyllostachys, Fargesia, Bambusa, Pseudosasa, and Guadadua. In another aspect, bamboo material is bamboo stem. In another aspect, bamboo material is bamboo leaves. In another aspect, bamboo material is bamboo fibers. In another aspect, bamboo material is bamboo pulp. In another aspect, bamboo material is bamboo grass. In another aspect, bamboo material can include, but is not limited to, bamboo stem, bamboo leaves, bamboo fibers, bamboo pulp, and bamboo grass. As used herein, the term “bamboo pulp” refers to the ground product of the wood stems of a bamboo plant. In an aspect, the bamboo pulp is ground through a mechanical or chemical process that separates the fibers of the bamboo from the bamboo plant. As used herein, the term “biopolymer” refers to a material produced by the cells of living organisms which create natural polymers. In an aspect, a polymer is polystyrene. In another aspect, a polymer is silk. In another aspect, a polymer is nylon. In another aspect, a polymer is polyester. In another aspect, a polymer is rayon. In another aspect, a polymer is a plastic, including but not limited to, polystyrene, silk, nylon, polyester, rayon, and biopolymers. In another aspect, a biopolymer is poly-3-hydroxybutyrate (PHB). In another aspect, a biopolymer is cellulose. In another aspect, a biopolymer is DNA. In another aspect, a biopolymer is RNA. In another aspect, a biopolymer is lipids. In another aspect, a biopolymer is collagen. In another aspect, a biopolymer is poly-hydroxyalkanoates (PHA). In another aspect, a biopolymer can include, but is not limited to, poly-3-hydroxybutyrate (PHB), cellulose, DNA, RNA, lipids, collagen, and poly-hydroxyalkanoates (PHA).

As used herein, the term “PHB-producing bacteria” refers to micro-organisms which produce poly-3-hydroxybutyrate (PHB). In an aspect, PHB-producing bacteria is Rhodopseudomonas palustris. In another aspect, PHB-producing bacteria is actinomycetes. In another aspect, PHB-producing bacteria is cyanobacteria. In another aspect, PHB-producing bacteria is Escherichia coli. In another aspect, PHB-producing bacteria is Saccharomyces cerevisiae. In another aspect, PHB-producing bacteria includes, but is not limited to, Rhodopseudomonas palustris, actinomycetes, cyanobacteria, Escherichia coli, and Saccharomyces cerevisiae.

As used herein, the term “insect repellent” refers to a substance used to discourage pests from landing on or being in proximity to a surface. In an aspect, insect repellent is a bio-insecticide. In another aspect, the bio-insecticide chemical structure comprises a benzene ring. In another aspect, the bio-insecticide benzene ring creates pi-stacking interactions between the bamboo fiber and bio-insecticide. As used herein, the term “pi-stacking” refers to interactions between neighboring aromatic rings attracting molecules containing benzene rings towards each other. In another aspect, insect repellent is Azadirachtin. In another aspect, insect repellent is Pyrethrins. In another aspect, insect repellent is Citronella Oil. In another aspect, insect repellent is Eucalyptus Oil. In another aspect, insect repellent is Lavendar Oil. In another aspect, insect repellent is Tea Tree Oil. In another aspect, insect repellent is Garlic Extract. In another aspect, insect repellent is Bacillus thuringiensis israelensis (Bti). In another aspect, insect repellent is Geranoil. In another aspect, insect repellent is Nepeta cataria. In another aspect, insect repellent is Peppermint Oil. In another aspect, insect repellent is Cedarwood Oil. In another aspect, insect repellent includes, but is not limited to, Azadirachtin, Pyrethrins, Citronella Oil, Lavendar Oil, Tea Tree Oil, Garlic Extract, Bacillus thuringiensis israelensis, Geranoil, Nepeta Cataria, Peppermint Oil, and Cedarwood Oil.

As used herein, the term “pest” refers to an animal harmful to humans or human concerns. In an aspect, a pest is spiders. In another aspect, a pest is insects. In another aspect, a pest includes, but is not limited to, spiders and insects. As used herein, the term “spiders” refers to the suborder Mesothelae. As used herein, the term “spiders” refers to the suborder Opisthothelae. As used herein, the term “spiders” refers to the orders Mesothelae and Opisthothelae. As used herein, the term “insects” refers to the order Hemiptera. As used herein, the term “insects” refers to the order Lepidoptera. As used herein, the term “insects” refers to the order Diptera. As used herein, the term “insects” refers to the order Hymenoptera. As used herein, the term “insects” refers to the order Coleoptera. As used herein, the term “insects” refers to the orders Hemiptera, Lepidoptera, Diptera, Hymenoptera, and Coleoptera. In an aspect, Hemiptera are the suborder Auchenorrhyncha. In an aspect, Hemiptera are the suborder Colcorrhyncha. In an aspect, Hemiptera are the suborder Heteroptera. In an aspect, Hemiptera are the suborder Sternorrhyncha. In another aspect, Hemiptera includes, but is not limited to, Auchenorrhyncha, Coleorrhyncha, Heteroptera, and Sternorrhyncha. In an aspect, Lepidoptera are the suborder Aglossata. In an aspect, Lepidoptera are the suborder Gloassata. In an aspect, Lepidoptera are the suborder Heterobathmiina. In an aspect, Lepidoptera are the suborder Zeugloptera. In another aspect, Lepidoptera includes, but is not limited to, Aglossata, Glossata, Heterobathmiina, Rhopalocera, and Zeugloptera. In an aspect, Diptera are the suborder Nematocera. In an aspect, Diptera are the suborder Brachycera. In another aspect, Diptera includes, but is not limited to, suborders Nematocera and Brachycera. In an aspect, Nematocera are the family Culicidae. As used herein, the term “mosquitos” refers to the family Culicidae. In an aspect, Culicidae are the subfamily Anophelinae. In an aspect, Culicidae are the subfamily Culicinae. In another aspect, Culicidae includes, but is not limited to, Anophelinae and Culicinae. In an aspect, Culicinae are the tribe Aedeomyiini. In an aspect, Culicinae are the tribe Aedini. In an aspect, Culicinae are the tribe Culicini. In an aspect, Culicinae are the tribe Culisetini. In an aspect, Culicinae are the tribe Ficalbiini. In an aspect, Culicinae are the tribe Hodgesiini. In an aspect, Culicinae are the tribe Mansoniini. In an aspect, Culicinae are the tribe Orthopodomyiini. In an aspect, Culicinae are the tribe Sabethini. In an aspect, Culicinae are the tribe Toxorhynchitini. In an aspect, Culicinae are the tribe Uranotaeniini. In another aspect, Culicinae include, but are not limited to, the tribes Acdcomyiini, Aedini, Culicini, Culisetini, Ficalbiini, Hodgesiini, Mansoniini, Orthopodomyiini, Sabethini, Toxorhynchitini, Uranotaeniini. In an aspect, Aedini are the genus Aedes. In another aspect, Aedini are the genus Armigeres. In another aspect, Aedini are the genus Eretmapodites. In another aspect, Aedini are the genus Fredwardsius. In another aspect, Aedini are the genus Haemagogus. In another aspect, Aedini are the genus Maeleaya. In another aspect, Aedini are the genus Ochlerotatus. In another aspect, Aedini are the genus Opifex. In another aspect, Aedini are the genus Psorophora. In another aspect, Aedini are the genus Scutomyia. In another aspect, Aedini are the genus Skusea. In another aspect, Aedini are the genus Stegomyia. In an aspect, Hymenoptera are the suborder Symphyta. In an aspect, Hymenoptera are the suborder Apocrita. In another aspect, Hymenoptera include, but are not limited to, suborders Symphyta and Apocrita. In an aspect, Coleoptera are the suborder Adephaga. In an aspect, Coleoptera are the suborder Archostemata. In an aspect, Coleoptera are the suborder Myxophaga. In an aspect, Coleoptera are the suborder Protocoleoptera. In another aspect, Coleoptera include, but are not limited to, the suborders Adephaga, Archostemata, Myxophaga, Polyphaga, and Protocoleoptera.

As used herein, the term “slurry” refers to the mixture of denser solids suspended in a liquid. In an aspect, the slurry comprises a mixture of biopolymer and bamboo pulp. In another aspect, the slurry comprises a mixture of biopolymer, bamboo pulp, and insecticide. In another aspect, the slurry comprises Quercetin. As used herein “Quercetin” refers to a flavonoid present in bamboo that acts as an antioxidant and contains a benzene ring structure. In another aspect, the Quercetin is extracted from bamboo fiber using hot water. In another aspect, the hot water used to extract Quercetin is at least 90° F. In another aspect, Quercetin can pi-stack with bioinsecticides containing benzene rings.

As used herein, the term “injection molding” refers to the manufacturing process for producing parts by injecting liquid material into a mold.

As used herein, the term “compression molding” refers to the manufacturing process for producing parts by laying a liquid material into a mold and closed with a top force and pressure is applied to force the material into contact with all mold areas.

As used herein, the term “blow molding” refers to the manufacturing process for producing parts by blowing air into a material to create a hollow part.

As used herein, the term “thermoforming” refers to the manufacturing process for producing parts by heating a material to form a specific shape in a mold.

As used herein, the term “vacuum casting” refers to the manufacturing process for producing parts by using a vacuum to draw the liquid material into the mold.

As used herein, the term “subtractive manufacturing” refers to the manufacturing process for producing parts by removing from an existing part structure.

As used herein, the term “additive manufacturing” refers to the manufacturing process for producing parts by adding to an existing part structure.

Embodiment 1: A net comprising; a supporting structure; a mesh having an n-sided polygon aperture and comprising a bamboo/biopolymer composite, wherein n is 5 or more, and wherein the mesh is impregnated with insect repellant.

Embodiment 2: The net of embodiment 1, wherein the supporting structure comprises bamboo material.

Embodiment 3: The net of embodiment 1, wherein a biopolymer of the bamboo/biopolymer composite comprises poly-3-hydroxybutyrate (PHB).

Embodiment 4: The net of embodiment 3, wherein the bamboo/biopolymer composite is formed from bamboo pulp combined with the PHB.

Embodiment 5: The net of embodiment 4, wherein the composite is formed by the bamboo pulp cross-linking with the PHB.

Embodiment 6: The net of embodiment 1, wherein the mesh is formed via injection molding.

Embodiment 7: The net of embodiment 4, wherein the bamboo/PHB composite is formed by creating a slurry of bamboo pulp mixed with PHB and insect repellent.

Embodiment 8: The net of embodiment 7, wherein the bamboo/PHB composite comprises 10:1 ratio of bamboo to PHB.

Embodiment 9: The net of embodiment 7, wherein the bamboo/PHB composite comprises 5:1 ratio of bamboo to PHB.

Embodiment 10: The net of embodiment 7, wherein the bamboo/PHB composite comprises 20:1 ratio of bamboo to PHB.

Embodiment 11: The net of embodiment 7, wherein the insect repellent is Azadirachta.

Embodiment 12: The net of embodiment 7, wherein the insect repellent is bio-insecticide.

Embodiment 13: The net of embodiment 7, wherein the insect repellent contains a benzene ring.

Embodiment 14: The net of embodiment 7, wherein the insect repellent is less than 1.5% of the slurry by volume.

Embodiment 15: The net of embodiment 7, wherein the insect repellent is 1.5% of the slurry by volume.

Embodiment 16: The net of embodiment 7, wherein the insect repellent is between 1.5% to 3% of the slurry by volume.

Embodiment 17: The net of embodiment 7, wherein the insect repellent is less than 3% of the slurry by volume.

Embodiment 18: The net of embodiment 7, wherein the insect repellent is 3% of the slurry by volume.

Embodiment 19: The net of embodiment 7, wherein the insect repellent is less than 1.5% of the slurry by weight.

Embodiment 20: The net of embodiment 7, wherein the insect repellent is 1.5% of the slurry composite by weight.

Embodiment 21: The net of embodiment 7, wherein the insect repellent is between 1.5% to 3% of the slurry by weight.

Embodiment 22: The net of embodiment 7, wherein the insect repellent is less than 3% of the slurry by weight.

Embodiment 23: The net of embodiment 7, wherein the insect repellent is 3% of the slurry by weight.

Embodiment 24: The net of embodiment 3, wherein the PHB is extract from the cell walls of Rhodopseudomonas palustris.

Embodiment 25: The net of embodiment 3, wherein the PHB is isolated from PHB-producing bacteria.

Embodiment 26: The net of embodiment 1, wherein n is six.

Embodiment 27: The net of embodiment 1, wherein the aperture is a substantially regular polygon with interior angles within 25% of the equation ((n−2)×180)÷n.

Embodiment 28: The net of embodiment 1, wherein the n-sided polygon aperture is configured to prevent the passage of pests selected from a group consisting of: spiders and insects.

Embodiment 29: The net of embodiment 1, wherein the net is a mosquito net and the n-sided polygon aperture is configured to prevent the passage of mosquitos.

Embodiment 30: The net of embodiment 1, wherein the aperture is 1 mm to 12 mm in diameter.

Embodiment 31: The net of embodiment 1, wherein the aperture is less than 12 mm in diameter.

Embodiment 32: The net of embodiment 1, wherein the aperture is between 2 mm and 10 mm in diameter.

Embodiment 33: The net of embodiment 1, wherein the aperture is between 3 mm and 5 mm in diameter.

Embodiment 34: The net of embodiment 1, wherein the aperture is between 6 mm and 8 mm in diameter.

Embodiment 35: The net of embodiment 1, wherein the n-sided polygon aperture is pentagonal.

Embodiment 36: The net of embodiment 1, wherein the n-sided polygon aperture is hexagonal.

Embodiment 37: A method for manufacturing a net, comprising steps of: A) combining poly-3-hydroxybutyrate (PHB) with bamboo pulp in a slurry to form a bamboo/PHB composite; and B) molding the bamboo/PHB composite, such that a mesh with an n-sided shaped aperture is formed, wherein n is 5 or more.

Embodiment 38: The method of embodiment 37, wherein step B comprises a molding process selected from a group consisting of: injection molding, reaction injection molding, compression molding, blow molding, thermoforming, extrusion molding, vacuum casting, subtractive manufacturing, and additive manufacturing.

Embodiment 39: The method of embodiment 37, wherein the PHB is extracted from the cell walls of Rhodopseudomonas palustris.

Embodiment 40: The method of embodiment 37, wherein the PHB is chemically extracted from PHB-producing bacteria.

Embodiment 41: The method of embodiment 37, wherein the PHB is solvent extracted from PHB-producing bacteria.

Embodiment 42: The method of embodiment 37, wherein the bamboo/PHB composite comprises insect repellent.

Embodiment 43: The method of embodiment 42, wherein the insect repellent is Azadirachtin.

Embodiment 44: The method of embodiment 43, wherein a bamboo, Azadirachtin, and PHB blend is introduced into a mold using injection molding.

Embodiment 45: The method of embodiment 44, wherein the mold has hexagonal shapes.

Embodiment 46: The method of embodiment 37, comprising step C: attaching the mesh onto a bamboo structure.

Embodiment 47: The method of embodiment 37, wherein n is 6 and the shape is a polygon.

Embodiment 48: The method of embodiment 37, wherein the aperture is 1 mm to 12 mm in diameter.

Embodiment 49: The method of embodiment 37, wherein the aperture is less than 12 mm in diameter.

Embodiment 50: The method of embodiment 37, wherein the aperture is between 2 mm and 10 mm in diameter.

Embodiment 51: The method of embodiment 37, wherein the aperture is between 3 mm and 5 mm in diameter.

Embodiment 52: The method of embodiment 37, wherein the aperture is between 6 mm and 8 mm in diameter.

Embodiment 53: A net comprising; a mesh having an n-sided polygon aperture, wherein n is 5 or more, and wherein the mesh comprises a bamboo/biopolymer composite.

Embodiment 54: The net of embodiment 53, wherein the biopolymer is poly-3-hydroxybutyrate (PHB).

Embodiment 55: The net of embodiment 53, wherein the mesh is impregnated with insect repellent.

Embodiment 56: The net of embodiment 53, further comprising a bamboo supporting structure.

Embodiment 57: The net of embodiment 54, wherein the biopolymer is poly-3-hydroxybutyrate (PHB), and the mesh comprises a bamboo/PHB composite.

Embodiment 58: The net of embodiment 57, wherein the composite is formed from bamboo broken down into pulp, and wherein the pulp is combined with the PHB.

Embodiment 59: The net of embodiment 58, wherein the composite is formed by the bamboo pulp cross-linking with the PHB.

Embodiment 60: The net of embodiment 57, wherein the mesh is injection molding mesh.

Embodiment 61: The net of embodiment 53, wherein an n-sided polygon aperture is pentagonal.

Embodiment 62: The net of embodiment 53, wherein an n-sided polygon aperture is hexagonal.

Embodiment 63: The net of embodiment 57, wherein the composite is formed by creating a slurry of bamboo pulp mixed with PHB and insect repellent.

Embodiment 64: The net of embodiment 64, wherein the bamboo/PHB composite comprises 1:1 ratio of bamboo to PHB.

Embodiment 65: The net of embodiment 64, wherein the bamboo/PHB composite comprises 1:2 ratio of bamboo to PHB.

Embodiment 66: The net of embodiment 64, wherein the bamboo/PHB composite comprises 2:1 ratio of bamboo to PHB.

Embodiment 67: The net of embodiment 64, wherein the insect repellent is Azadirachta.

Embodiment 68: The net of embodiment 63, wherein the insect repellent is less than 1.5% of the slurry by volume.

Embodiment 69: The net of embodiment 63, wherein the insect repellent is 1.5% of the slurry by volume.

Embodiment 70: The net of embodiment 63, wherein the insect repellent is between 1.5% to 3% of the slurry by volume.

Embodiment 71: The net of embodiment 63, wherein the insect repellent is less than 3% of the slurry by volume.

Embodiment 72: The net of embodiment 63, wherein the insect repellent is 3% of the slurry by volume.

Embodiment 73: The net of embodiment 63, wherein the insect repellent is less than 1.5% of the slurry by weight.

Embodiment 74: The net of embodiment 63, wherein the insect repellent is 1.5% of the slurry by volume.

Embodiment 75: The net of embodiment 63, wherein the insect repellent is between 1.5% to 3% of the slurry by weight.

Embodiment 76: The net of embodiment 63, wherein the insecticide is less than 3% of the slurry by weight.

Embodiment 77: The net of embodiment 63, wherein the insecticide is 3% of the slurry by weight.

Embodiment 78: The net of embodiment 54, wherein the PHB is extracted from the cell walls of Rhodopseudomonas palustris.

Embodiment 79: The net of embodiment 54, wherein the PHB is isolated from PHB-producing bacteria.

Embodiment 80: The net of embodiment 53, wherein n is six.

Embodiment 81: The net of embodiment 53, wherein the n-sided polygon aperture is a substantially regular polygon with interior angles within 25% of the equation ((n−2)×180)÷n.

Embodiment 82: The net of embodiment 53, wherein the n-sided polygon aperture is configured to prevent the passage of pests selected from a group consisting of: spiders and insects.

Embodiment 83: The net of embodiment 53, wherein the net is a mosquito net, and wherein n-sided polygon aperture is configured to prevent the passage of mosquitos.

Embodiment 84: The net of embodiment 53, wherein the aperture is 1 mm to 12 mm in diameter.

Embodiment 85: The net of embodiment 53, wherein the aperture is less than 12 mm in diameter.

Embodiment 86: The net of embodiment 53, wherein the aperture is between 2 mm and 10 mm in diameter.

Embodiment 87: The net of embodiment 53, wherein the aperture is between 3 mm and 5 mm in diameter.

Embodiment 88: The net of embodiment 53, wherein the aperture is between 6 mm and 8 mm in diameter.

### EXAMPLES

The examples herein are provided to illustrate advantages and benefits of the present technology and to further assist a person of ordinary skill in the art with preparing or using compositions of the present technology. The examples herein are also presented in order to more fully illustrate the preferred aspects of the present technology. The examples should in no way be construed as limiting the scope of the present disclosure, as defined by the appended claims. The examples can include or incorporate any of the variations, aspects or embodiments of the present technology described above. The variations, aspects or embodiments described above may also further each include or incorporate the variations of any or all other variations, aspects or embodiments of the present technology.

### Example 1: Manufacturing of Insect Net

Bamboo pulp and polyhydroxybutyrate (PHB) are combined at a 10:1 ratio to form the bamboo/biopolymer composite. The bamboo/biopolymer composite is mixed with 1.5% Azadirichta insecticide by volume. The resulting bamboo/biopolymer/insecticide composite is injected into a hexagonal mesh mold. The composite in the mold is allowed to dry for at least 12 hours. Once the mesh has dried, the mesh is attached to a bamboo as depicted in FIG. 1. See FIG. 5A.

### Example 2: Alternative Manufacturing of Insect Net

Bamboo pulp and polyhydroxybutyrate (PHB) are combined at a 10:1 ratio with 1.5% Azadirichta insecticide by volume to form the bamboo/biopolymer composite. The resulting composite is injected into a hexagonal mesh mold. The composite in the mold is allowed to dry for at least 12 hours. Once the mesh has dried, the mesh is attached to a bamboo as depicted in FIG. 1. See FIG. 5B.

1. A net comprising:
a supporting structure; and
a mesh having an n-sided polygon aperture and comprising a bamboo/biopolymer composite, wherein n is 5 or more, and wherein the mesh is impregnated with an insect repellant.

2. The net of claim 1, wherein the supporting structure comprises bamboo material.

3. The net of claim 1, wherein a biopolymer of the bamboo/biopolymer composite comprises poly-3-hydroxybutyrate (PHB).

4. The net of claim 3, wherein the bamboo/biopolymer composite is formed from bamboo pulp combined with the PHB.

5.-10. (canceled)

11. The net of claim 1, wherein the insect repellent is Azadirachta.

12.-29. (canceled)

30. The net of claim 1, wherein the aperture is 1 mm to 12 mm in diameter.

31.-34. (canceled)

35. The net of claim 1, wherein the n-sided polygon aperture is pentagonal or hexagonal.

36. (canceled)

37. A method for manufacturing a net, the method comprising:
(A) combining poly-3-hydroxybutyrate (PHB) with bamboo pulp in a slurry to form a bamboo/PHB composite; and
(B) molding the bamboo/PHB composite to form a mesh with an n-sided shaped aperture, wherein n is 5 or more.

38. The method of claim 37, wherein the molding comprises a molding process selected from a group consisting of: injection molding, reaction injection molding, compression molding, blow molding, thermoforming, extrusion molding, vacuum casting, subtractive manufacturing, and additive manufacturing.

39.-41. (canceled)

42. The method of claim 37, wherein the bamboo/PHB composite comprises an insect repellent.

43. The method of claim 42, wherein the insect repellent is Azadirachtin.

44. (canceled)

45. (canceled)

46. The method of claim 37, wherein the method further comprises (C) attaching the mesh onto a bamboo structure.

47. (canceled)

48. The method of claim 37, wherein the aperture is 1 mm to 12 mm in diameter.

49.-52. (canceled)

53. A net comprising a mesh having an n-sided polygon aperture, wherein n is 5 or more, and wherein the mesh comprises a bamboo/biopolymer composite.

54. The net of claim 53, wherein the biopolymer is poly-3-hydroxybutyrate (PHB).

55. The net of claim 53, wherein the mesh is impregnated with an insect repellent.

56. The net of claim 53, wherein the net further comprises a bamboo supporting structure.

57.-60. (canceled)

61. The net of claim 53, wherein the n-sided polygon aperture is pentagonal or hexagonal.

62.-66. (canceled)

67. The net of claim 55, wherein the insect repellent is Azadirachta.

68.-83. (canceled)

84. The net of claim 53, wherein the aperture is 1 mm to 12 mm in diameter.

85.-88. (canceled)
